(19) United States
(12) Patent Application Publication
(10) Pub. No.: US 2017/0037865 A1
(43) Pub. Date: Feb. 9, 2017

(54) FORGED MATERIAL FOR ROTOR, AND METHOD FOR MANUFACTURING ROTOR BASED ON FORGED MATERIAL FOR ROTOR

(71) Applicant: UACJ Foundry & Forging Corporation, Tokyo (JP)

(72) Inventors: Zenji SHIMIZU, Oyama-shi (JP); Kazuaki KONDO, Oyama-shi (JP)

(73) Assignee: UACJ Foundry & Forging Corporation, Tokyo (JP)

(21) Appl. No.: 15/227,768

(22) Filed: Aug. 3, 2016

(30) Foreign Application Priority Data
Aug. 5, 2015 (JP) 2015-154750

(51) Int. Cl. F04D 29/28

(52) U.S. Cl. CPC F04D 29/284; F05B 2230/10; F05B 2230/25; F05B 2280/1073

(57) ABSTRACT

Provided is a forged material for a rotor for obtaining, by machining, a rotor including a hub portion and a plurality of blade portions. The forged material for a rotor comprises a hub forming section and a plurality of blade forming sections that one-to-one correspond to the plurality of blade portions. The plurality of blade portions each comprise a first end face that faces an outer peripheral surface of the hub portion and a second end face opposite from the first end face. The plurality of blade forming sections each comprise a blade-shaped surface having a shape that follows at least part of a contour of the second end face of the one-to-one corresponding blade portion.

### CROSS-REFERENCE TO RELATED APPLICATIONS

This application claims the benefit of Japanese Patent Application No. 2015-154750 filed Aug. 5, 2015 in the Japan Patent Office, the disclosure of which is incorporated herein by reference.

### BACKGROUND

The present disclosure relates to a forged material for a rotor, and a method for manufacturing a rotor based on the forged material for a rotor.

Rotors are known, such as compressor impellers for use in compressors for automobiles, ships, and so on. Such a rotor comprises a hub portion and a plurality of blade portions provided so as to stand on an outer peripheral surface of the hub portion. The rotors are manufactured by easting or by machining a material such as a cast material, an extruded, material, and a forged material. Specifically, compressor impellers for use in automotive turbochargers have conventionally been manufactured by casting; however, manufacture by machining a material is becoming mainstream in recent years with the aim of cost reduction and so on. In the case where the compressor impeller is manufactured by machining, the material can be selected from a cast material, an extruded material, a forged material, and so on. In terms of weight reduction and high-temperature strength, manufacture by machining an aluminum alloy forged material has been increasing.

The rotor is used under severe conditions of high temperature and high-speed rotation, depending on its application. For example, a compressor impeller for use in an automotive turbocharger is used under severe conditions of high temperature of around 200° C. and high-speed rotation of 100,000-200,000 revolutions/minute. Thus, high mechanical properties (specifically high fatigue strength under high-temperature environment) are required. Therefore, in manufacturing the compressor impeller, it is preferred to use a forged material having high mechanical properties for manufacture by machining. For example, Japanese Unexamined Patent Application Publication No. 2006-305629 discloses a method for preparing a forged material for a rotor that has high mechanical properties by controlling crystal grains uniformly.

In such a method, the forged material having a solid shape (a bell-like shape) is first prepared. Then, a rotor is manufactured by machining the forged material. However, when the forged material is machined to manufacture the rotor, residual stress is likely to be generated within the machined rotor because so many portions of the forged material have been machined. In addition, since the shape of the forged material is a bell-like shape, which is very different from a shape of an end product, metallographic structure, specifically grain flow lines (metal flow), within the forged material is likely to be cut when the forged material of the bell-like shape is machined to form the blades. These factors may lead to deteriorated mechanical properties (specifically fatigue strength under high-temperature environment) of the machined rotor, and thus, a fatigue crack may be generated in the rotor when the rotor is used for a long period of time under severe conditions of high temperature and high-speed rotation.

In one aspect of the present disclosure, it is preferred to provide a forged material for a rotor that allows for improvement of mechanical properties, specifically fatigue strength under high-temperature environment, of a rotor obtained by machining, and a method for manufacturing the rotor based on the forged material for a rotor.

### SUMMARY

A forged material for a rotor according to one aspect of the present disclosure is a forged material for a rotor of aluminum alloy for obtaining, by machining, a rotor including a hub portion and a plurality of blade portions provided so as to stand on an outer peripheral surface of the hub portion. The forged material for a rotor comprises a hub forming section, which is a preform of the hub portion; and a plurality of blade forming sections, which are preforms of the plurality of blade portions and which one-to-one correspond, to the plurality of blade portions. The plurality of blade portions each comprise a first end face that faces the outer peripheral surface of the hub portion and a second end lace opposite from the first end face. The plurality of blade forming sections each comprise a blade-shaped surface having a shape that follows at least part of a contour of the second end face of the one-to-one corresponding blade portion.

In the above-described forged material for a rotor (hereinafter simply referred to as a forged material as appropriate), each blade forming section is provided with the blade-shaped surface having a shape that follows the contour of the second end face of the corresponding blade portion of the rotor. Thus, when the forged material is machined to manufacture the rotor, grain flow lines (metal flow) within the forged material can be inhibited from being cut due to machining. Specifically, when each blade forming section is machined to form the corresponding blade portion, the grain flow lines can be inhibited from being cut due to machining, in the Wade-shaped surface of each blade forming section.

As a result, the second end face of each blade portion is a surface in which cutting of the grain flow lines is inhibited. Here, the less the grain flow lines on the second end face (the surface to come in contact with a fluid, for example) of each blade portion are cut, the less likely a fatigue crack is to be generated. If no fatigue crack is generated, crack propagation does not occur even after the rotor Is repeatedly subjected to a fluid force while rotating at high speed, for example. Thus, it is possible to seek improvement of fatigue strength of each blade portion (specifically, a base portion thereof connected to the hub portion) of the rotor obtained by machining the forged material.

Moreover, by providing each blade forming section with the blade-shaped surface, the forged material allows for reduction of a machining amount of the forged material when the forged material is machined to manufacture the rotor. In particular, a machining amount at the time when the plurality of blade forming sections are machined to form the plurality of blade portions can be reduced. This enables reduction of residual stress generated within the machined rotor. Here, residual stress also has a significant influence on generation and propagation of a fatigue crack. Specifically, when the machined, rotor has been subjected to the same stress, a fatigue crack is likely to be generated and likely to be propagated if residual stress is large. Thus, reduction of residual stress in the rotor obtained by machining the forged material makes it possible to seek improvement of fatigue strength of the rotor. Additionally, reduction of portions to be machined enables Improvement of productivity, material yield, etc.

As described above, two aspects of the forged material, i.e., low occurrence of cutting of the grain flow lines due to machining and reduced residual stress, make it possible to improve mechanical properties, specifically fatigue strength under high-temperature environment, of the rotor obtained by machining the forged material. Thus, even when the rotor, which is for example applied to a compressor impeller for use in an automotive turbocharger, is used for a long period of time under severe conditions of high temperature (e.g., around 200° C.) and high-speed rotation (e.g., 100,000-200,000 revolutions/minute), generation and propagation of a fatigue crack in the rotor can be inhibited, and thus, durability and reliability of the rotor can be enhanced.

The forged material is designed for manufacture of the rotor by machining. The rotor is, for example, a compressor impeller for use in a compressor of an automobile, a ships, and so on. Specifically, a compressor impeller for use in a turbocharger and a supercharger of an automobile and a ship, a compressor impeller for use in an electric generator, and so on are listed as examples. In the rotor, the hub portion is a portion to become a rotating shaft portion while the rotor is rotated. The plurality of blade portions are portions to introduce a fluid when the rotor is rotated.

The forged material is made of aluminum alloy. As aluminum alloy, JIS 6000, JIS 7000, or JIS 2000 series aluminum alloy, etc., having a high-temperature strength can be used, for example. The forged material can be manufactured by forging (hot forging, etc.) aluminum alloy. The forged material can have a specified shape including the hub forming section and the plurality of blade forming sections by closed-die-forging, etc., using a die or the like.

The plurality of blade forming sections are designed for formation of the plurality of blade portions by machining. The plurality of blade forming sections each may be a section from which one blade portion is formed. In forming the plurality of blade portions, the respective blade portions may have the same shape, or may have a different shape. Further, the number of the plurality of blade forming sections is not limited to a particular one. One blade forming section may be provided.

The blade-shaped surface has a shape that follows the contour of the second end face. The second end face is a face opposite from the first end face that faces the outer peripheral surface of the hub portion in each blade portion. The shape that follows the contour of the second end lace refers to, for example, a surface approximately parallel to the second end face, and refers to a surface formed so that, when the blade-shaped surface is machined to form the second end face, a machining thickness is approximately constant. “Approximately parallel to the second end surface” docs not require being perfectly parallel to the second end face, and it Is acceptable if it is within ±15 degrees with respect to the second end face, .for example. Here, in the forged material obtained by forging aluminum alloy, the grain flow lines within the forged material are formed along (approximately parallel to) a surface of the forged material, especially in a surface portion of the forged material. Thus, when the second end face is formed by machining along (approximately parallel to) the blade-shaped surface, cutting of the grain flow lines within the forged material due to machining can be inhibited.

The blade-shaped surface has a shape that follows at least part of the contour of the second end face. That is, the blade-shaped surface may have a shape that follows part of the contour of the second end face, or may have a shape that follows an entire contour of the second end face. Alternatively, the blade-shaped surface may be provided to some of the plurality of blade forming sections, or may be provided to every blade forming section.

In the forged material, the blade-shaped surface may be provided at least in a radially outer end portion of each of the plurality of blade forming sections. Specifically, the radially outer end portion of each of the plurality of blade forming sections is a portion (corresponding to an outer peripheral portion of the rotor) that is especially subjected to a centrifugal force and a fluid force (air force, for example, in the case of the automotive turbocharger) when the machined rotor is rotated, and thus, the radially outer end portion is a portion required to have higher fatigue strength. Therefore, by providing the blade-shaped surface in such a portion, it is possible to effectively exert an effect of improving mechanical properties, specifically fatigue strength under high-temperature environment, of the rotor obtained by machining. It is preferred that the blade-shaped surface is provided at least in a region within 10% of a radial length from an outer end of the blade forming section, for example.

Further, the blade-shaped surface may be provided at least in a portion corresponding to the outer peripheral portion in each blade forming section. It is preferred that the blade-shaped surface is provided at least in the portion corresponding to the outer peripheral portion of the rotor in each blade forming section and corresponding to a region within 10% of a radius from an outer periphery (outer end) of the rotor, for example.

The plurality of blade portions may each comprise one or more blades. The plurality of blade forming sections may each comprise a first part, which is a preform of a first blade as the one or more blades, and a second part, which is a preform of a second blade as the one or more blades, and the second blade is shorter in an axial length than the first blade. The blade-shaped surface may comprise a first blade-shaped surface corresponding to the first blade. In this case, it becomes easier to form the first blade and the second blade, which are different in axial length from each other, by machining the blade forming section of the forged material. In addition, the effect of inhibiting the grain flow lines within the forged material from being cut due to machining can be obtained sufficiently. The axial length of the blade means a length (height) of the blade in an axial direction of the rotor. The blade-shaped surface corresponding to the first blade means the blade-shaped surface having a shape that follows at least part of the contour of the second end face of the first blade.

The plurality of blade forming sections may each comprise a first forming section including the first part and the second part; and a second forming section including a remaining part, which is a preform of a remainder of the second blade. The first forming section may comprise the first blade-shaped surface, and the second forming section may comprise a second blade-shaped surface corresponding to the second blade. In this case, it becomes easier to form the first blade and the second blade, which are different in axial length from each other, by machining the blade forming section of the forged material. In addition, the effect of inhibiting the grain flow lines within the forged material from being cut due to machining can be further enhanced. The remainder of the second blade means the other part excluding the part of the second blade formed in the first forming section. The blade-shaped surface corresponding to the second blade means the blade-shaped surface having a shape that follows at least part of the contour of the second end face of the second blade.

The rotor may be a compressor impeller. For example, a compressor impeller for use in an automotive turbocharger is used for a long period of time under severe conditions of high temperature and high-speed rotation, and thus, high mechanical properties, specifically high fatigue strength under high-temperature environment, are required. Therefore, it is effective to manufacture the rotor using the forged material that allows for improvement of mechanical properties, specifically fatigue strength under high-temperature environment, of the rotor obtained by machining.

A method for manufacturing a rotor according to another aspect of the present disclosure comprises a machining step of machining the forged material for a rotor to obtain the above-described rotor.

With the method for manufacturing a rotor, it is possible to obtain the rotor having high mechanical properties, specifically high fatigue strength under high-temperature environment, by performing the machining step. Thus, even when the rotor, which is for example applied to a compressor impeller for use in an automotive turbocharger, is used for a long period of time under severe conditions of high temperature and high-speed rotation, generation and propagation of a fatigue crack in the rotor can be inhibited, and thus, durability and reliability of the rotor can be enhanced.

In the method for manufacturing a rotor, in the machining step, machining may be performed approximately parallel to the blade-shaped surface of each of the plurality of blade forming sections, to thereby form the second end face. In this case, the effect of inhibiting the grain flow lines within the forged material from being cut due to machining can be enhanced. “Approximately parallel to the blade-shaped surface” does not require being perfectly parallel to the blade-shaped surface, and it is acceptable if it is within ±15 degrees with respect to the blade-shaped surface, for example.

### BRIEF DESCRIPTION OF THE DRAWINGS

Exemplary embodiments will now be described by way of example with reference to the accompanying drawings, in which:

FIG. 1 is a perspective view showing a compressor impeller of Embodiment 1;

FIG. 2 is a plan view showing the compressor impeller of Embodiment 1;

FIG. 3 is a sectional view taken along a line III-III in FIG. 2;

FIG. 4 is a perspective view showing a forged material of Embodiment 1;

FIG. 5 is a plan view showing the forged material of Embodiment 1;

FIG. 6 is a sectional view taken along a line VI-VI in FIG. 5;

FIG. 7 is a perspective view showing a forged material of Embodiment 2;

FIG. 8 is a plan view showing the forged material of Embodiment 2;

FIG. 9 is a sectional view taken along a line IX-IX in FIG. 8;

FIG. 10 is a perspective view showing a compressor impeller of Example 2;

FIG. 11 is a plan view showing the compressor impeller of Example 2;

FIG. 12 is a perspective view showing a forged material of Example 5;

FIG. 13 is a schematic diagram showing grain flow lines within compressor impellers of Examples 1-3; and

FIG. 14 is a schematic diagram showing grain flow lines within compressor impellers of Comparative Examples 4 and 5.

### DETAILED DESCRIPTION OF TOE PREFERRED EMBODIMENTS

### Embodiment 1

A rotor of the present embodiment is a compressor impeller for use in an automotive turbo charger. Thus, a forged material for a rotor of the present embodiment is a forged material for a compressor impeller.

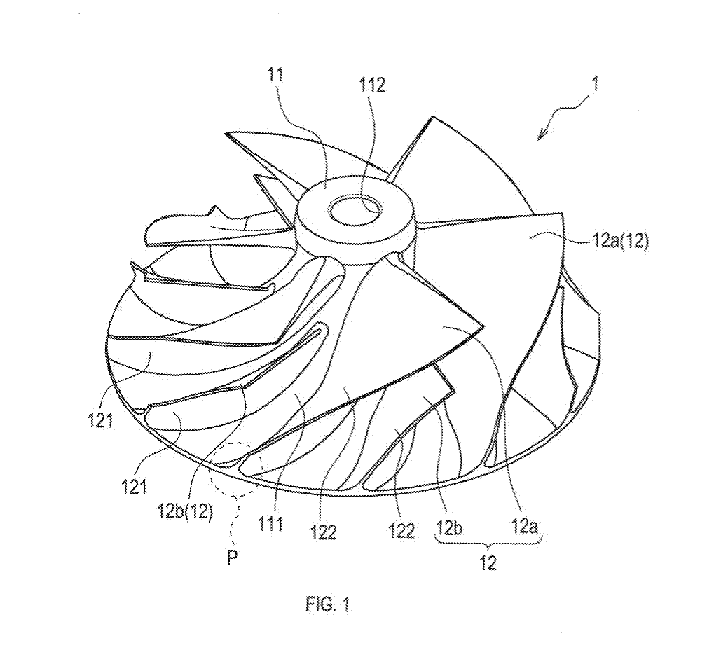

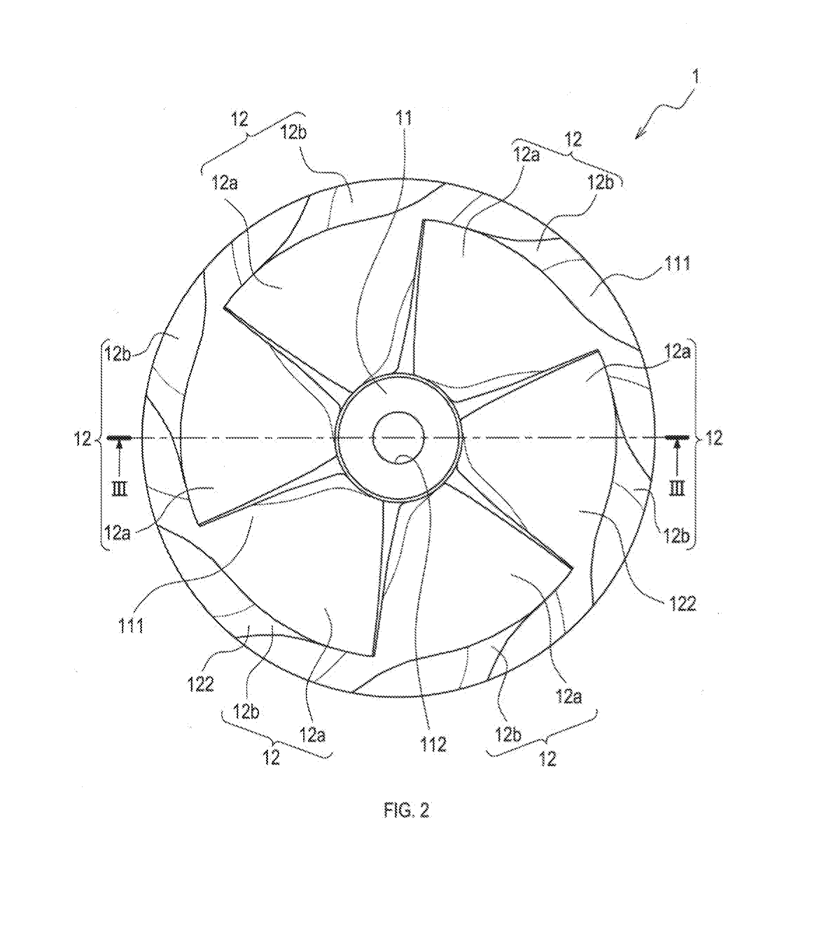

First, a compressor impeller will be described with reference to FIGS. 1-3.

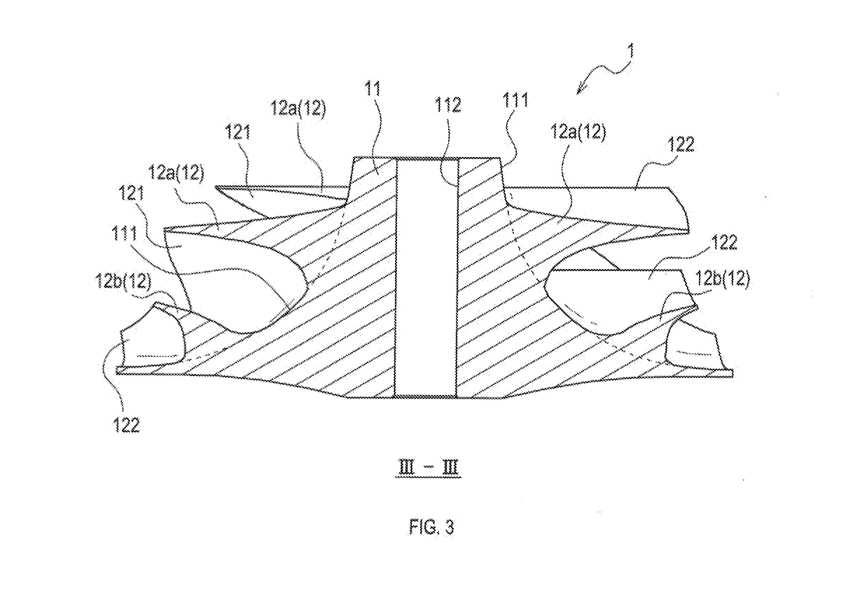

A compressor impeller 1 is made of aluminum alloy. The compressor impeller 1 is obtained by machining a forged material 2 of aluminum alloy, which will be described later. At an upper side of FIG. 3 is one axial end (an upper end) of the compressor impeller 1, and at a lower side of FIG. 3 is the other axial end (a lower end).

The compressor impeller 1 comprises a hub portion 11, and a plurality of blade portions 12 provided on an outer peripheral surface 111 of the hub portion 11. In the compressor impeller 1 of the present embodiment, the number of the plurality of blade portions 12 is six in total.

The hub portion 11 has an approximately truncated conical shape formed so as to be gradually larger in outside diameter from the one axial end (the upper end) toward the other axial end (the lower end). The hub portion 11 has a through hole 112 provided so as to axially run through from the one axial end (the upper end) to the other axial end (the lower end). The compressor impeller 1 is rotated about a central axis of the hub portion 11 by rotation of a compressor shaft (not shown) inserted into the through hole 112.

The plurality of blade portions 12 are formed integrally with the hub portion 11. The plurality of blade portions 12 are each provided so as to project from the outer peripheral surface 111 of the hub portion 11. Each blade portion 12 (a long blade 12a, a short blade 12b) has a thin plate shape, and comprises a first end face 121, which is one end face (a surface on one side) in a thickness direction, and a second end face 122, which is the other end face (a surface on the other side). The first end face 121 is directed toward the other axial end (the lower end), and is curved so as to face the outer peripheral surface 111 of the hub portion 11. The second end face 122, which is a surface to come in contact with a fluid, is directed toward the one axial end (the upper end), and is curved so as to be directed toward a side opposite from the side the first end face 121 is directed toward.

Each blade portion 12 includes the long blade 12a (a first blade) and the short blade 12b (a second blade), which Is shorter in axial length (axial height) than the long blade 12a. A plurality (six) of the long blades 12a are provided correspondingly to the plurality of blade portions 12. The six long blades 12a are arranged at regular intervals in a circumferential direction. A plurality (six) of the short blades 12b are provided correspondingly to the plurality of blade portions 12. The six short blades 12b are arranged at regular intervals in the circumferential direction. The plurality (six) of long blades 12a and the plurality (six) of short blades 12b are arranged alternately with each other in the circumferential direction. One of the plurality of short blades 12b is arranged so that part of such short blade 12b axially overlaps one of the plurality of long blades 12a adjacent to such short blade 12b. The same applies to the remaining plurality of long blades 12a and the remaining plurality of short blades 12b.

Next, the forged material, for a compressor impeller (hereinafter simply referred to as a forged material) will be described.

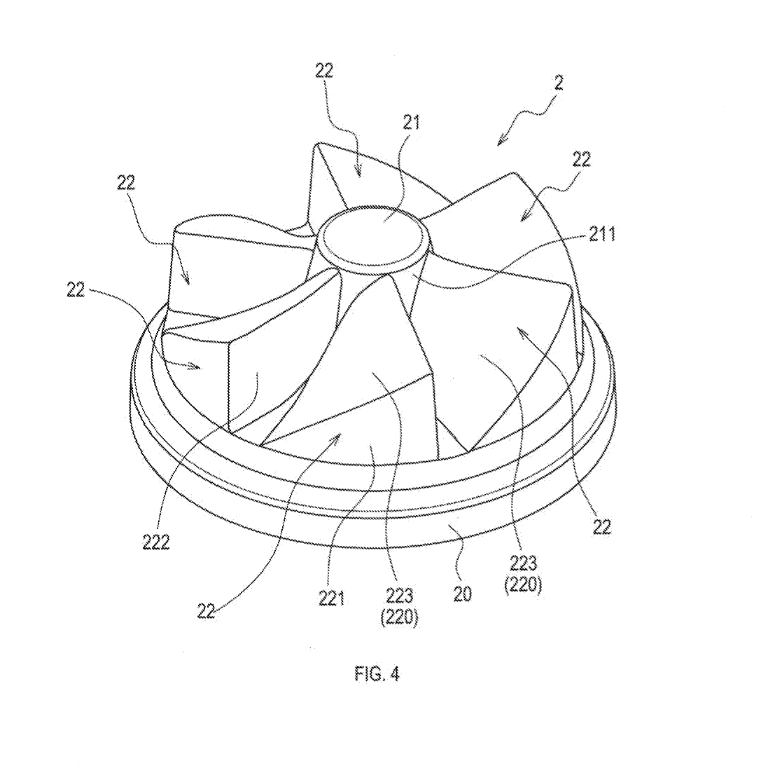

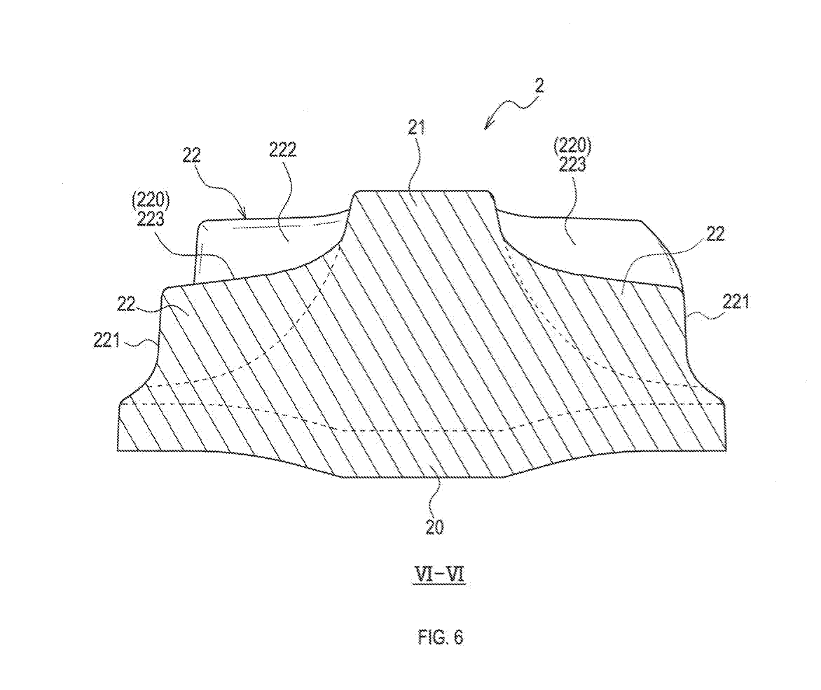

As shown in FIGS. 4-6, the forged material 2 comprises a hub forming section 21 from which the hub portion 11 is to be formed, and a plurality of blade forming sections 22 from which the plurality of blade portions 12 are to be formed. The hub forming section 21 is a preform of the hub portion 11, and the plurality of blade forming sections 22 are preforms of the plurality of blade portions 12. The plurality of blade forming sections 22 are each provided with a blade-shaped surface 220. The blade-shaped surface 220 has a shape that follows at least part of a contour of the second end face 122. The second end face 122 is a surface opposite from the first end face 121, which nearly faces the outer peripheral surface 111 of the hub portion 11. Details of the forged material 2 will be described below.

The forged material 2 is made of aluminum alloy. Since the compressor impeller 1 is used under conditions of high temperature and high-speed rotation, JIS 6000, JIS 7000, or JIS 2000 series aluminum alloy, etc., having a high-temperature strength can be used.

The forged material 2 comprises a base section 20, the hub forming section 21, and the plurality (six) of blade forming sections 22. The base-section 20, the hub forming section 21, and the plurality (six) of blade forming sections 22 constituting the forged material 2 are integrally formed.

The base section 20 is a foundation for the hub forming section 21 and the plurality of blade forming sections 22. The base section 20 has an approximately disk-like shape. Most of the base section 20 is to be removed by machining (machining for obtaining the compressor impeller 1) in a later step.

The hub forming section 21 is a section to mainly form the hub portion 11 by being machined in the later step. The hub forming section 21 has an appropriately truncated conical shape. The hub forming section 21 is provided on the base section 20 integrally with the base section 20.

The plurality of blade forming sections 22 are provided on an outer peripheral surface 211 of the hub forming section 21. The plurality of blade forming sections 22 are arranged at regular intervals in a circumferential direction. Each of the plurality of blade forming sections 22 is machined in the later step, and the corresponding blade portion 12 is thereby formed. Each blade portion 12 includes the corresponding long blade 12a (the first blade) and the corresponding short blade 12b (the second blade). Each blade forming section 22 includes a part (a first part) from which the corresponding long blade 12a is to be formed and a part (a second part) from which the corresponding short blade 12b is to be formed.

Each blade forming-section 22 has three surfaces, i.e., a first surface 221, a second surface 222, and a third surface 223.

The first surface 221 is formed so as to stand approximately vertically in an axial direction of the hub forming section 21. The first surface 221 is curved along a circumferential direction. The first surface 221 has an approximately triangular shape.

The second surface 222 is formed so as to stand approximately vertically in the axial direction of the hub forming section 21. The second surface 222 is a surface that extends along a radial direction (that is approximately perpendicular to the circumferential direction). The second surface 222 has an approximately triangular shape.

The third surface 223 is an inclined surface formed so as to stand at a specified inclination angle. The third surface 223 has an approximately fan-like shape as viewed planarly (as viewed axially from above).

In each blade forming section 22, the second surface 222 and the third surface 223 are formed in a circumferentially continuous manner. The second surface 222 of the blade forming section 22 (provisionally referred to as a primary blade forming section 22) is formed in a circumferentially continuous manner with the third surface 223 of another blade forming section 22 (provisionally referred to as a secondary blade forming section 22), which is adjacent to the primary blade forming section 22. In other words, the third surface 223 of the secondary blade forming section 22 is formed in a circumferentially continuous manner with the second surface 222 of the main blade forming section 22.

Provided in each blade forming section 22 is the blade-shaped surface 220 having the shape that follows the contour of the second end face 122 of the long blade 12a. In the present embodiment, the entirety of the third surface 223 of each blade forming section 22 forms the blade-shaped surface 220.

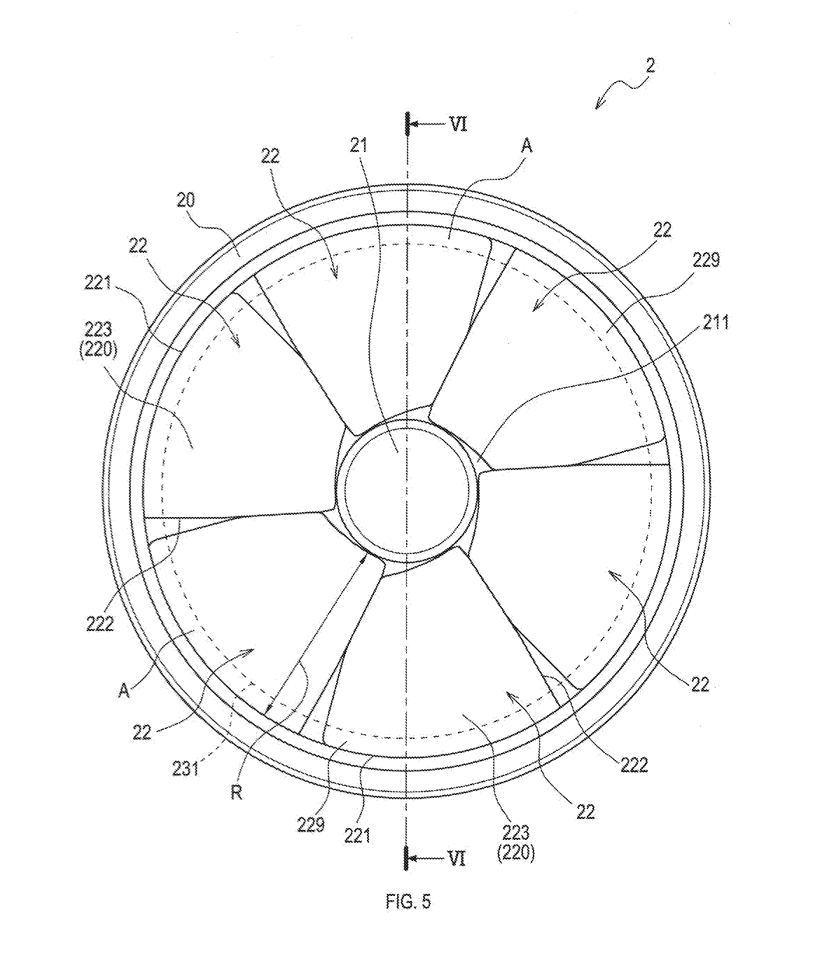

The blade-shaped surface 220 is provided at least in a radially outer end portion 229 (hereinafter simply referred to as an end portion 229) of each blade forming section 22. The end portion 229 is formed in a radially outer region in each blade forming section 22. Further, the blade-shaped surface 220 is provided at least in an outer region A, which is a region within 10% of a radial length R from an outer end of the blade forming section 22 (FIG. 5). In the present embodiment, the outer region A is a region between the first surface 221 and a dotted line 231 in the blade forming section 22, and the blade-shaped surface 220 is provided throughout the radial direction of the blade forming section 22 including the outer region A.

Next, a method for preparing the forged material 2 will be described.

In preparing the forged material 2, aluminum alloy was first melted. Since the compressor impeller 1 is used under the conditions of high temperature and high-speed rotation, JIS 6000, JIS 7000, at JIS 2000 series aluminum alloy, etc., having a high-temperature strength can be used.

Next, an extrusion billet (an ingot adjusted for extrusion) prepared from the aluminum alloy was subjected to homogenization treatment, and was extruded by means of a general extruder. In this way, an extruded material of a round bar shape was obtained, and cut to a specified length.

Then, the extruded material was hot-forged under temperature conditions of 300-500° C. Specifically, the extruded material was closed-die-forged by means of a general forging machine. In the closed-die-forging, a die of a specified shape (a die capable of forming the forged material 2 in FIGS. 4-6) was used. In this way, an intermediate forged, material was obtained.

Subsequently, the intermediate forged material was debarred, and then subjected to solution treatment, quenching, and artificial aging treatment in this order. As a result, the forged material 2 including the base section 20, the hub forming section 21, and the six blade forming sections 22 as shown in FIGS. 4-6 was prepared.

Next, a method for manufacturing the compressor impeller 1 based on the forged material 2 will be described.

The method for manufacturing the compressor impeller 1 (a rotor) comprises a machining step of machining the forged material 2 (a forged material for a rotor) to obtain the compressor impeller 1 (the rotor). Details of the method for manufacturing the compressor impeller 1 will be described below.

In manufacturing the compressor impeller 1, the forged material 2 as shown in FIGS. 4-6 was machined to obtain a specified shape (the machining step). The machining may be performed by applying a general machine work. In the present embodiment, the forged material 2 was machined using a lathe and a five-axis machining center.

Specifically, the hub forming section 21 of the forged material 2 was machined to form the hub portion 11 having the through hole 112. Also, the plurality of blade forming sections 22 of the forged material 2 were machined to form the plurality of blade portions 12 (the plurality of long blades 12a and the plurality of short blades 12b). In particular, as for the blade-shaped surface 220 of each blade forming section 22, the blade forming section 22 was machined approximately parallel to the corresponding blade-shaped surface 220, thereby to form the second end face 122. Here, “approximately parallel to the corresponding blade-shaped surface 220” does not require being perfectly parallel to the blade-shaped surface 220, and it is acceptable if it is within ±15 degrees with respect to the blade-shaped surface 220, for example.

In this way, the compressor impeller 1 as shown in FIGS. 1-3 was manufactured that comprises the hub portion 11 of an approximately truncated conical shape, and the six blade portions 12 (the six long blades 12a and the six short blades 12b) provided on the outer peripheral surface 111 of the hub portion 11.

Next, effects of the present embodiment will be described.

In the forged material 2 (the forged material for a rotor) of the present embodiment, each blade forming section 22 is provided with the blade-shaped surface 220 having a shape that follows the contour of the second end face 122 of the long blade 12a of the compressor impeller 1 (the rotor). Thus, when the forged material 2 is machined to manufacture the compressor impeller 1, grain flow lines (metal flow) within the forged material 2 can be inhibited from being cut due to machining. Specifically, when each blade forming section 22 is machined to form the blade portion 12 (the long blade 12a), the grain flow lines can be inhibited from being cut due to machining, in the blade-shaped surface 220 of each blade forming section 22.

As a result, the thus-formed second end lace 122 of each long blade 12a is a surface in which cutting of the grain flow lines is inhibited. Here, the less the grain flow lines on the second end face 122 (the surface to come in contact with a fluid) of each long blade 12a are cut, the less likely a fatigue crack is to be generated. If no fatigue crack is generated, crack propagation does not occur even after the compressor impeller 1 is repeatedly subjected to a fluid force while rotating at high speed. Thus, it is possible to seek improvement of fatigue strength of each blade portion 12 (especially, a base portion thereof connected to the hub portion 11) of the compressor impeller 1 obtained by machining the forged material 2.

Moreover, by providing each blade forming section 22 with the blade-shaped surface 220, the forged material 2 allows for reduction of a machining amount of the forged material 2 when the forged material 2 is machined to manufacture the rotor. In particular, a machining amount at the time when the plurality of blade forming sections 22 are machined to form the plurality of blade portions 12 (the plurality of long blades 12a) can be reduced. This enables reduction of residual stress generated within the machined compressor impeller 1. Here, residual stress also has a significant influence on generation and propagation of a fatigue crack. Specifically, when the machined compressor impeller 1 has been subjected to the same stress, a fatigue crack is likely to be generated and likely to be propagated if residual stress is large. Thus, reduction of residual stress in the compressor impeller 1 obtained by machining the forged material 2 makes it possible to seek improvement of fatigue strength of the compressor impeller 1. Additionally, reduction of portions to be machined enables improvement of productivity, material yield, etc.

As described above, two aspects of the forged material 2, i.e., low occurrence of cutting of the grain flow lines due to machining and reduced residual stress, make it possible to improve mechanical properties, specifically fatigue strength under high-temperature environment, of the compressor impeller 1 obtained by machining the forged material 2. Thus, even when the compressor impeller 1 is used for a long period of time under severe conditions of high temperature (e.g., around 200° C.) and high-speed rotation (e.g., 100,000-200,000 revolutions/minute), generation and propagation of a fatigue crack in the compressor impeller 1 can be inhibited, and thus, durability and reliability of the compressor impeller 1 can be enhanced.

In the forged material 2 of the present embodiment, the blade-shaped surface 220 may be provided at least in the end portion 229 of each blade forming section 22. Specifically, each end portion 229 (corresponding to an outer peripheral portion of the compressor impeller 1) is a portion that is especially subjected, to a centrifugal force and a fluid force when the machined compressor impeller 1 is rotated, and thus, each end portion 229 is a portion required to have higher fatigue strength. Therefore, by providing the blade-shaped surface 220 in such a portion, it is possible to effectively exert an effect of improving mechanical properties, specifically fatigue strength under high-temperature environment, of the compressor impeller 1 obtained by machining.

Each blade forming section 22 includes the part (the first part) from which the corresponding long blade 12a (the first blade) is to be formed and the part (the second part) from which the corresponding short blade 12b (the second blade) is to be formed, which is shorter in axial length than the long blade 12a (the first blade), and also includes the blade-shaped surface 220 (a first blade-shaped surface) corresponding to the long blade 12a (the first blade). This makes it easier to form the plurality of long blades 12a and the plurality of short blades 12b, which are different in axial length from each other, by machining the plurality of blade forming sections 22 of the forged material 2. In addition, the effect of inhibiting the grain flow lines within the forged material 2 from being cut due to machining can be obtained sufficiently.

The method for manufacturing the compressor impeller 1 (the rotor) of the present embodiment comprises the machining step of machining the forged material 2 to obtain the compressor impeller 1. This makes it possible to obtain the compressor impeller 1 having improved mechanical properties, specifically high fatigue strength under high-temperature environment. Thus, even when the compressor impeller 1 is used for a long period of time under severe conditions of high temperature and high-speed rotation, generation and propagation of a fatigue crack, etc., in the compressor impeller 1 can be inhibited, and thus, durability and reliability of the compressor impeller 1 can be enhanced.

In the machining step, machining is performed approximately parallel to the blade-shaped surface 220 to form the second end face 122 of the long blade 12a. This makes it possible to enhance the effect of inhibiting the grain flow lines within the forged material 2 from being cut due to machining.

As described above, the present embodiment can provide the forged material 2 for the compressor impeller 1 (the forged material for a rotor) that allows for improvement of mechanical properties specifically fatigue strength under high-temperature environment, of the compressor impeller 1 (the rotor) obtained by machining, and the method for manufacturing the compressor impeller 1 (the rotor) based on the forged material 2.

### Embodiment 2

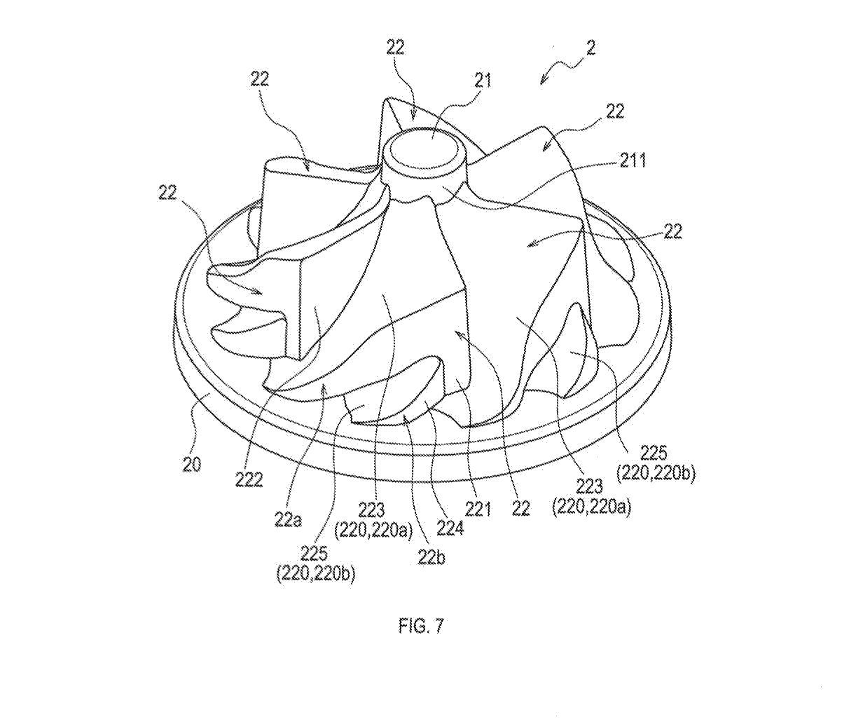

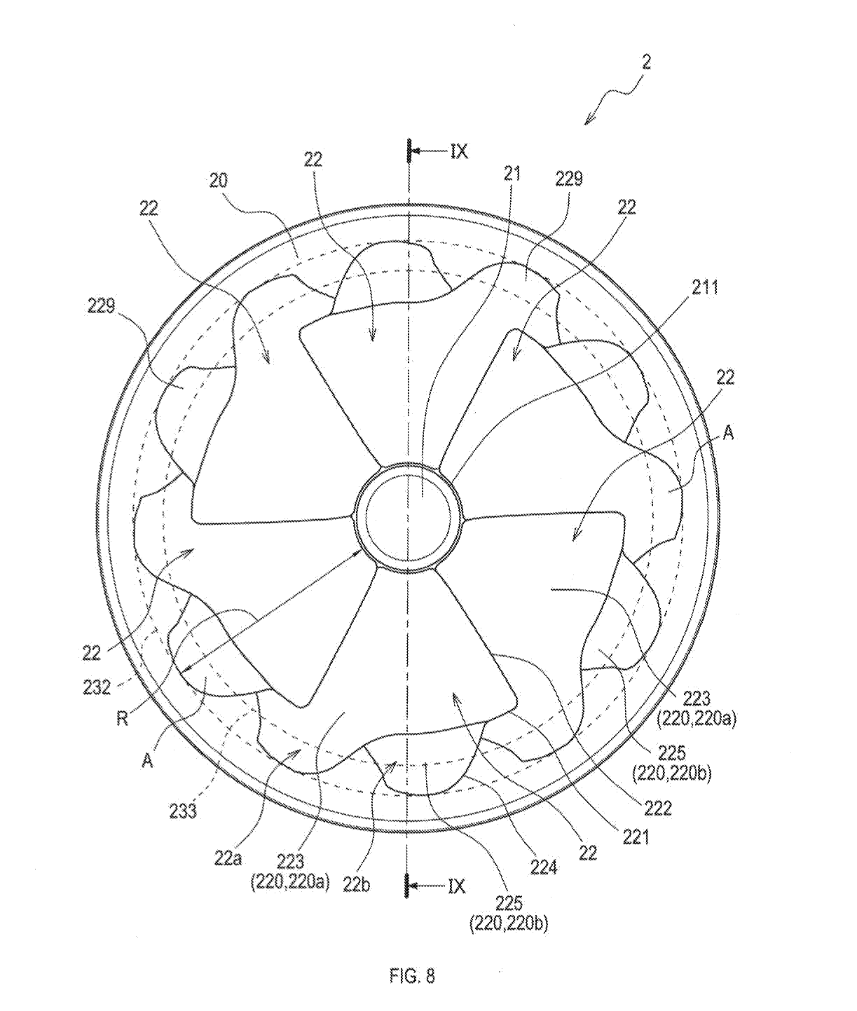

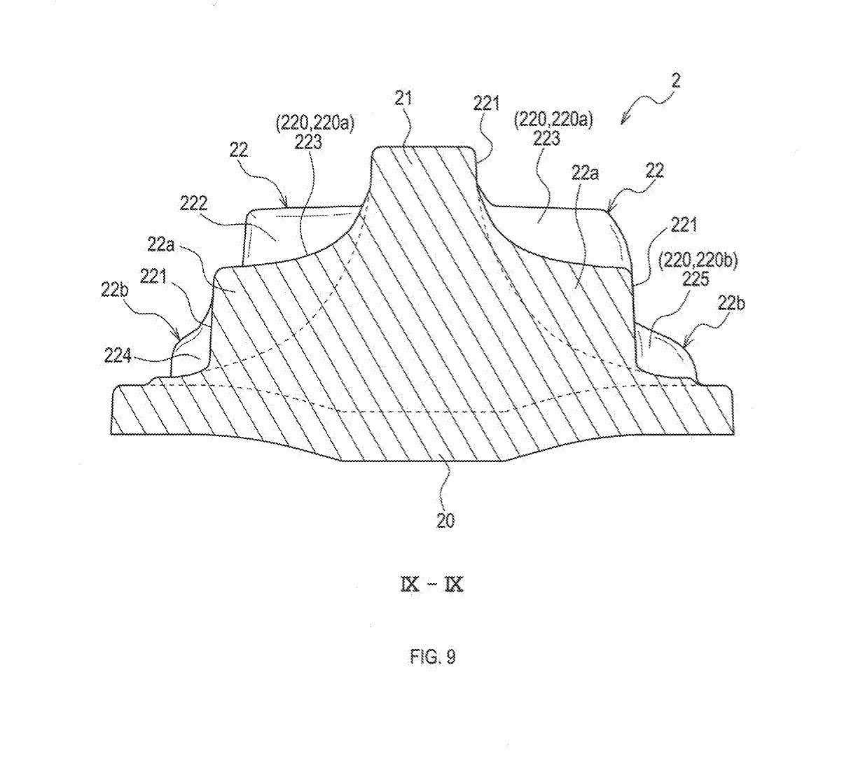

As shown in FIGS. 7-9, the present embodiment is an example in which the structure of the plurality of blade forming sections 22 in the forged material 2 is modified. Explanations of elements and effects similar to those of Embodiment 1 will be omitted.

Each blade forming section 22 comprises a first forming section 22a and a second forming section 22b. The first forming section 22a includes the part (the first part) from which the long blade 12a is to be formed and the part (the second part) from which part of the short blade 12b is to be formed. The second forming section 22b includes a part from which a remainder of the short blade 12b is to be formed. Here, the remainder of the short blade 12b means the other part excluding the part of the short blade 12b formed in the first forming section 22a.

Each first forming section 22a includes the first surface 221, the second surface 222, and the third surface 223. Differently from Embodiment 1, the first surface 221 is formed such that part of the first surface 221 is recessed radially inward. Each second forming section 22b is provided so as to project radially outward from a radially-inwardly recessed part of the first surface 221.

Each second forming section 22b comprises two surfaces, i.e., a fourth surface 224 and a fifth surface 225. The fourth surface 224 is formed so as to stand approximately vertically in an axial direction on the outer peripheral surface 211 of the hub forming section 21. The fourth surface 224 is a surface formed so as to be curved obliquely with respect to a radial direction (a circumferential direction) from the first surface 221 of the first forming section 22a. The fourth surface 224 has an approximately triangular shape. The fifth surface 225 is an inclined surface formed so as to stand at a specified inclination angle on the outer peripheral surface 211 of the hub forming section 21. The fifth surface 225 has an approximately triangular shape.

The first forming section 22a of each blade forming section 22 is provided with the blade-shaped surface 220 (a long blade-shaped surface 220a: the first blade-shaped surface) having a shape that follows the contour of the second end face 122 of the long blade 12a. In the present embodiment, the entirety of the third surface 223 of the first forming section 22a is the long blade-shaped surface 220a having a shape that follows the contour of the second end face 122 of the long blade 12a.

The second forming section 22b of each blade forming section 22 is provided with the blade-shaped surface 220 (the short blade-shaped surface 220b: a second blade-shaped surface) having a shape that follows part of a contour of the second end face 122 of the short blade 12b. In the present embodiment, the entirety of the fifth surface 225 of the second forming section 22b is the short blade-shaped surface 220b having the shape that follows the contour of the second end face 122 of the short blade 12b.

The blade-shaped surface 220 (the long blade-shaped surface 220a, the short blade-shaped surface 220b) is provided at least in the end portion 229 of each blade forming section 22. The blade-shaped surface 220 (the long blade-shaped surface 220a, the short blade-shaped surface 220b) is provided at least in the outer region A, which is the region within 10% of the radial length R from the outer end of each blade forming section 22. In the present embodiment, the outer region A is a region between a dotted line 232 and a dotted line 233 in each blade forming section 22. The long blade-shaped surface 220a is provided throughout the radial direction of the blade forming section 22 including the outer region A. The short blade-shaped surface 220b is provided in the end portion 229 of the blade forming section 22 including the outer region A.

Next, effects of the present embodiment will be described.

In the forged material 2 of the present embodiment, each blade forming section 22 comprises the first forming section 22a including the part (the first part) from which the long blade 12a (the first blade) is to be formed and the part (the second part) from which part of the short blade 12b (the second blade) is to be formed; and the second forming section 22b including the part (the remaining part) from which the remainder of the short blade 12b (the second blade) is to be formed. Furthermore, the first forming section 22a is provided with the blade-shaped surface 220 (the long blade-shaped surface 220a: the first blade-shaped surface) corresponding to the long blade 12a (the first blade), and the second forming section 22b is provided with the blade-shaped surface 220 (the short blade-shaped surface 220b: the second blade-shaped surface) corresponding to the short blade 12b (the second blade).

This makes it easier to form, the plurality of long blades 12a and the plurality of short blades 12b, which are different in axial length from each other, by machining the plurality of blade forming sections 22 of the forged material 2. In addition, the effect of inhibiting the grain flow lines within the forged material 2 from being cut due to machining can be further enhanced.

### Experimental Example

Examples of the present disclosure will be described below while comparing them with comparative examples, to thereby demonstrate the effects of the present disclosure. These examples show the embodiments of the present disclosure, and the present disclosure is not limited to them.

In the present experimental example, a plurality of compressor impellers (Examples 1-3 and Comparative Examples 4 and 5) were produced, and fatigue strengths of them were measured and evaluated. Table 1 shows types of alloys, materials before machining, shapes before machining, and shapes after machining.

In Examples 1-3, a cylindrical extruded material having a diameter of 40 mm and a length (height) of 40 mm was prepared from aluminum alloy (JIS A 2618). Then, the extruded material was hot-forged at 400° C. to obtain a forged material of a specified shape. The shape of the forged material in Examples 1 and 2 is similar to that of the forged material 2 of the above-described Embodiment 1 (a shape (a), see FIGS. 4-6). The shape of the forged material in Example 3 is similar to that of the forged material 2 of the above-described Embodiment 2 (a shape (b), see FIGS. 7-9). However, since sixteen blades (sixteen blade portions) are to be formed, the forged material of Embodiment 2 was formed to have sixteen blade forming sections.

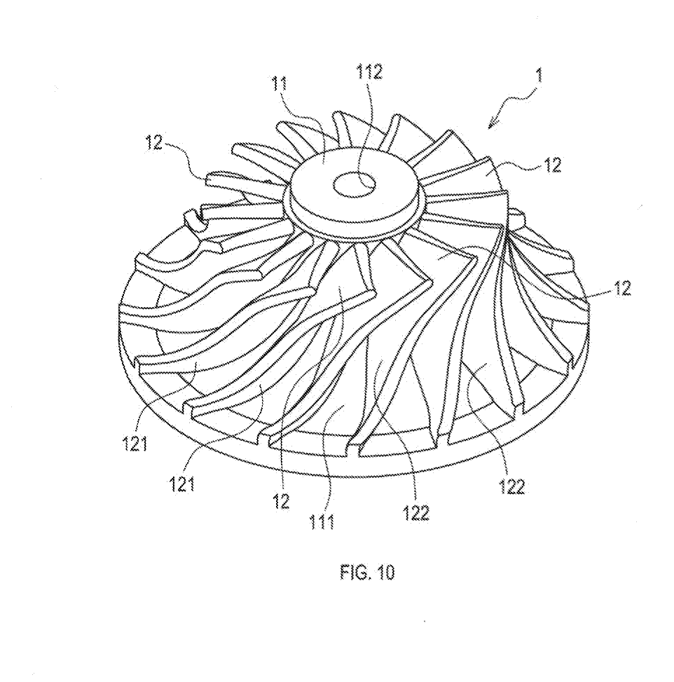

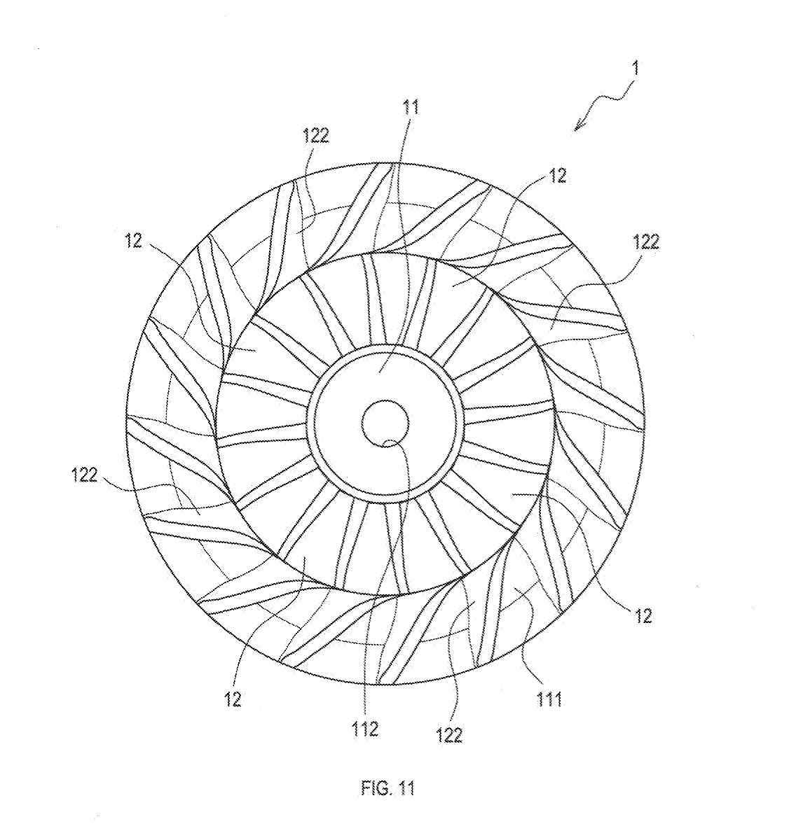

Subsequently, the forged material was subjected to solution treatment at 530° C. for two hours, quenched in water of 90° C., and further subjected to artificial aging treatment at 200° C. for 20 hours. The obtained forged material was machined to produce a compressor impeller of a specified shape. The shape of the compressor impellers in Examples 1 and 3 is similar to that of the compressor impeller 1 of the above-described Embodiments 1 and 2 (a shape (A), see FIGS. 1-3) The shape of the compressor impeller in Example 2 is similar to that of the compressor impeller 1 shown in FIGS. 10 and 11 (a shape (B)).

Here, the compressor impeller 1 shown in FIGS. 10 and 11 will be described. The compressor impeller 1 comprises the hub portion 11, and the sixteen blade portions 12 provided on the hub portion 11. The respective blade portions 12 all have the same shape, which is similar to that of the long blade 12a of Embodiments 1 and 2.

In Comparative Example 4, a cylindrical extruded material having a diameter of 62 mm and a length (height) of 36 mm was prepared from aluminum alloy (JIS A 2618). A shape of the extruded material is cylindrical (a shape (c)). Then, the extruded material was subjected to solution treatment at 530° C. for two hours, quenched in water of 90° C., and further subjected to artificial aging treatment at 200° C. for 20 hours. The obtained extruded material was machined to produce a compressor impeller. A shape of the compressor impeller is similar to that of the compressor impeller 1 of the above-described Embodiments 1 and 2 (the shape (A), see FIGS. 1-3).

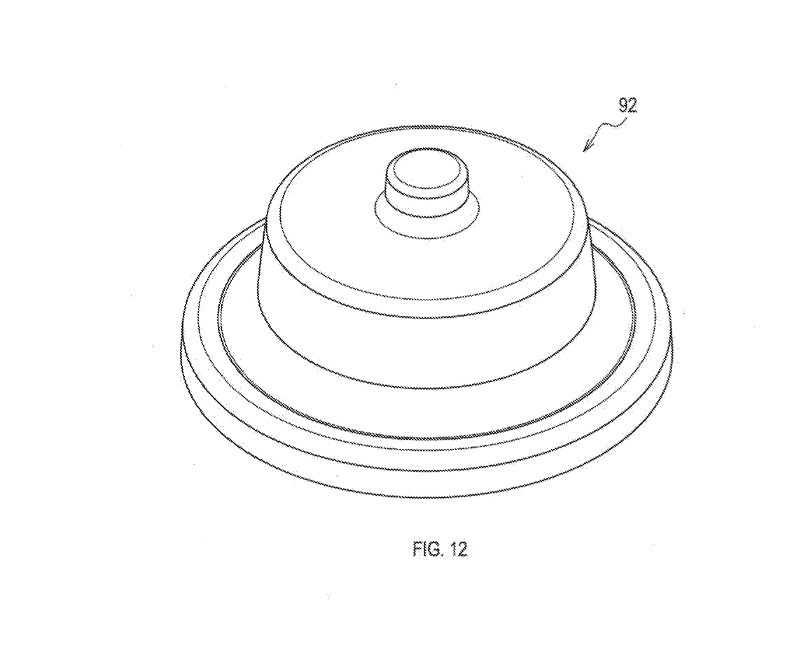

In Comparative Example 5, a cylindrical extruded material having a diameter of 40 mm and a length (height) of 40 mm was prepared from aluminum alloy (JIS A 2618). Then, the extruded material was hot-forged at 400° C. to obtain a forged material of a specified shape. The shape of the forged material is similar to that of a forged material 92 shown in FIG. 12 (a shape (d)). Here, the forged material 92 shown in FIG. 12 will be described. The shape of the forged material 92 is a solid shape (a bell-like shape) obtained by rotating a shape obtained by projecting a compressor impeller to be produced, in a direction perpendicular to a rotation axis of the compressor impeller.

Subsequently, the forged material was subjected to solution treatment at 530° C. for two hours, quenched in water of 90° C., and further subjected to artificial aging treatment at 200° C. for 20 hours. The obtained forged material was machined to produce the compressor impeller. A shape of the compressor impeller is similar to that of the compressor impeller 1 of the above-described Embodiments 1 and 2 (the shape (A), see FIGS. 1-3).

The thus-produced plurality of compressor impellers (Examples 1-3 and Comparative Examples 4 and 5) were subjected to a fatigue test. In the fatigue test, each of the compressor impellers was rotated for a specified period of time under conditions of temperature of 200° C. and the number of revolutions of 200,000 rpm, and presence/absence of generation and propagation of a fatigue crack in the compressor impeller was evaluated. The periods of time of the fatigue tests for Comparative Examples 4 and 5 shown in Table 1 are periods upon elapse of which generation and propagation of a fatigue crack was observed.

TABLE 1

| | | | | | | Fatigue Test | | | |
|---|---|---|---|---|---|---|---|---|---|
| | | Type of | Material | Shape | Shape | | Number of | Time | |
| | | Aluminum | before | before | after | Temperature | Revolutions | Period | |
| | | Alloy | Machining | Machining | Machining | (° C.) | (rpm) | (hr) | Evaluation |
| Examples | 1 | 2618 | Forged | Shape (a) | Shape (A) | 200 | 200,000 | 217 | ◯ |
| | | | material | | | | | | |
| | 2 | | Forged | Shape (a) | Shape (B) | | | 213 | ◯ |
| | | | material | | | | | | |
| | 3 | | Forged | Shape (b) | Shape (A) | | | 225 | ◯ |
| | | | material | | | | | | |
| Comparative | 4 | | Extruded | Shape (c) | Shape (A) | | | 181 | X |
| Examples | | | Material | | | | | | |
| | 5 | | Forged | Shape (d) | Shape (A) | | | 185 | X |
| | | | material | | | | | | |

As seen from Table 1, in each of the compressor impellers of Comparative Examples 4 and 5, before elapse of 200 hours from the start of the fatigue test, a fatigue crack was generated at a base portion of the blade at an outer peripheral portion of the compressor impeller. Then, the fatigue crack propagated to the hub portion, where rupture occurred (results of the fatigue test: X (poor)).

On the other hand, in each of the compressor impellers of Examples 1-3, generation and propagation of a fatigue crack was not observed even after elapse of 200 hours from the start of the fatigue test (results of the fatigue test: ◯ (good)). In each of Examples 2 and 3, the blade-shaped surface is provided correspondingly to every blade, whereas in Example 1, only the blade-shaped surface corresponding to the long blade is provided and the blade-shaped surface corresponding to the short blade is not provided. Nevertheless, even in the case where the blade-shaped surface is not provided correspondingly to every blade as in Example 1, generation and propagation of a fatigue crack was not observed. Thus, it has been found that the effect of improving mechanical properties (specifically fatigue strength under high-temperature environment) can be obtained sufficiently even in such a case.

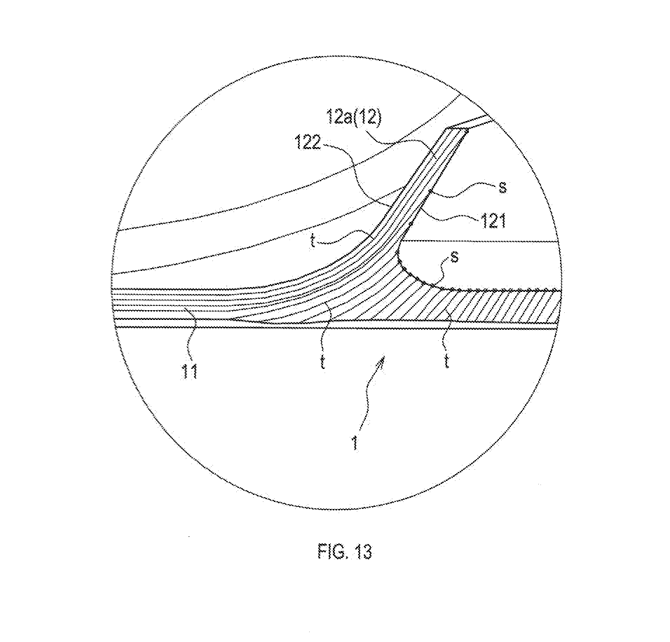

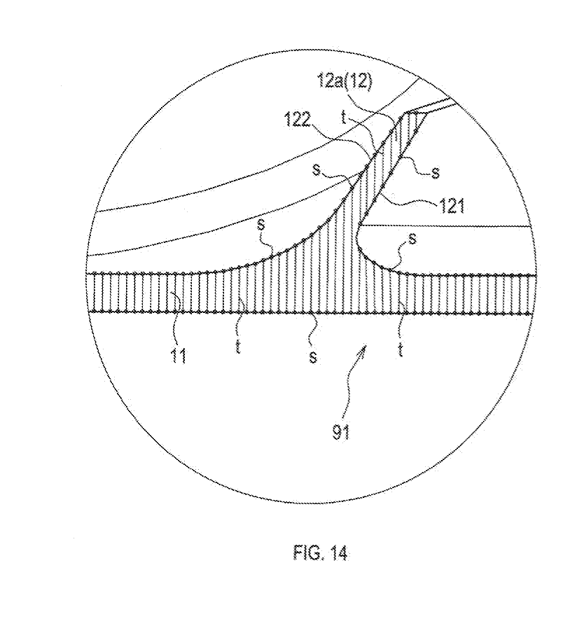

Here, FIG. 13 schematically shows grain flow lines within the compressor impellers of Examples 1-3, and FIG. 14 schematically shows grain flow lines within the compressor impellers of Comparative Examples 4 and 5. FIG. 13 is an enlarged view of a part (circled by a dotted line P in FIG. 1) of an outer peripheral portion of the compressor impeller 1 corresponding to Examples 1-3, and FIG. 14 is an enlarged view of a part (equivalent to that depicted in FIG. 13) of an outer peripheral portion of a compressor impeller 91 corresponding to Comparative Examples 4 and 5.

As seen from FIG. 14, grain flow lines (t) are present in an axial direction within the compressor impeller 91 corresponding to Comparative Examples 4 and 5. Thus, a lot of cut ends (s) of the grain flow lines (t) (intersections between the grain flow lines (t) and the surface) are present on the second end face 122. Moreover, a lot of cut ends (s) of the grain flow lines (t) are also present on the first end face 121. Furthermore, a lot of cut ends (s) of the grain flow lines (t) are also present on the other portion. Thus, it is inferred that, in the fatigue tests, such a structure caused generation and propagation of the fatigue crack in the compressor impellers of Comparative Examples 4 and 5.

On the other hand, as seen from FIG. 13, within the compressor impeller 1 corresponding to Examples 1-3, the grain flow lines (t) are present along the second end face 122. Thus, the cut ends (s) of the grain flow lines (t) are not present on the second end face 122. Moreover, the cut ends (s) of the grain flow lines (t) on the first end face 121 are also less than those seen in FIG. 14. Furthermore, the cut ends (s) of the grain flow lines (t) on the other portion are also less than those seen in FIG. 14. Thus, it is inferred that, in the fatigue tests, generation and propagation of a fatigue crack was not caused in the compressor impellers of Examples 1-3 due to such a structure.

### Other Embodiments

The present disclosure is not limited to the above-described embodiments, and it is needless to say that the present disclosure can be practiced in various forms without departing from the scope of the present disclosure.

(1) In the above-described Embodiments 1 and 2, the rotor is the compressor impeller 1 for use in an automotive turbocharger. However, the rotor may be, for example, a compressor impeller for use in an automotive, supercharger, a compressor impeller for use in a ship turbocharger and supercharger, a compressor impeller for use in an electric generator, and the like.

(2) In the above-described Embodiments 1 and 2, the compressor impeller 1 comprises two types of blades having different axial lengths, i.e., the long blades 12a and the short blades 12b. However, the compressor impeller 1 may comprise a plurality of blades of only one type as shown in FIGS. 10 and 11, for example.

(3) In the above-described Embodiments 1 and 2, each blade forming section 22 of the forged material 2 is a section from which a plurality of blades (the long blade 12a and the short blade 12b) are formed. However, each blade forming section 22 may be a section from which a single blade is formed, for example. That is, the blade forming section may be provided for each blade (in other words, the number of blade forming sections may be equal to that of the blades).

(4) In the above-described Embodiment 1, each blade forming section 22 of the forged material 2 is shaped so as to have the first surface 221, the second surface 222, and the third surface 223. However, the shape of each blade forming section is not limited to this, and a wide variety of shapes can be adopted as long as it is a section from which the blade is formed.

(5) In the above-described Embodiment 2, each first forming section 22a of the forged material 2 is shaped so as to have the first surface 221, the second, surface 222, and the third surface 223, and each second forming section 22b is shaped so as to have the fourth surface 224 and the fifth surface 225. However, the shapes of the first forming section and the second forming section are not limited to these, and a wide variety of shapes can be adopted as long as they are sections from which the blade is formed.

(6) In the above-described Embodiments 1 and 2, the third surface 223 (the blade-shaped surface 220) of each blade forming section 22 has the shape that follows an entire contour of the second end face 122 of the long blade 12a. However, the third surface 223 (the blade-shaped surface 220) may have a shape that follows part of the contour of the second end face 122 of the long blade 12a, for example.

(7) In the above-described Embodiments 1 and 2, the entirety of the third surface 223 of each blade forming section 22 is the blade-shaped surface 220 corresponding to the long blade 12a. However, part of the third surface 223 of the blade forming section 22 may be the blade-shaped surface 220, for example.

(8) In the above-described Embodiment 2, the entirety of the fifth surface 225 of each blade forming section 22 is the blade-shaped surface 220 corresponding to the short blade 12b. However, part of the fifth surface 225 of the blade forming section 22 may be the blade-shaped surface 220, for example.

What is claimed is:

1. A forged material for a rotor of aluminum alloy for obtaining, by machining, a rotor including a hub portion and a plurality of blade portions provided so as to stand on an outer peripheral surface of the hub portion, the forged material comprising:
a hub forming section, which is a preform of the hub portion; and
a plurality of blade forming sections, which are preforms of the plurality of blade portions and which one-to-one correspond to the plurality of blade portions,
wherein the plurality of blade portions each comprise a first end face that face's the outer peripheral surface of the hub portion and a second end face opposite from the first end face, and
wherein the plurality of blade forming sections each comprise a blade-shaped surface having a shape that follows at least part of a contour of the second end face of the one-to-one corresponding blade portion.

2. The forged material for a rotor according to claim 1,
wherein the blade-shaped surface is provided at least in a radially outer end portion of each of the plurality of blade forming sections.

3. The forged material for a rotor according to claim 1,
wherein the plurality of blade portions each comprise one or more blades,
wherein the plurality of blade forming sections each comprise a first part, which is a preform of a first blade as the one or more blades, and a second part, which is a preform of a second blade as the one or more blades, the second blade being shorter in an axial length than the first blade, and
wherein the blade-shaped surface comprises a first blade-shaped surface corresponding to the first blade.

4. The forged material for a rotor according to claim 3,
wherein the plurality of blade forming sections each comprise a first forming section including the first part and the second part; and a second forming section including a remaining part, which is a preform of a remainder of the second blade, and
wherein the first forming section comprises the first blade-shaped surface, and the second forming section comprises a second blade-shaped surface corresponding to the second blade.

5. The forged material for a rotor according to claim 1,
wherein the rotor is a compressor impeller.

6. A method for manufacturing a rotor, the method comprising:
a machining step of machining a forged material for a rotor of aluminum alloy for obtaining, by machining, a rotor including a hub portion and a plurality of blade portions provided so as to stand on an outer peripheral surface of the hub portion, the forged material comprising:
a hub forming section, which is a preform of the hub portion; and
a plurality of blade forming sections, which are preforms of the plurality of blade portions and which one-to-one correspond to the plurality of blade portions,
wherein the plurality of blade portions each comprise a first end face that faces the outer peripheral surface of the hub portion and a second end face opposite from the first end face, and
wherein the plurality of blade forming sections each comprise a blade-shaped surface having a shape that follows at least part of a contour of the second end face of the one-to-one corresponding blade portion.

7. The method for manufacturing a rotor according to claim 6,
wherein, in the machining step, machining is performed approximately parallel to the blade-shaped surface of each of the plurality of blade forming sections, to thereby form the second end face.
